(19) United States
(12) Patent Application Publication
(10) Pub. No.: US 2018/0194245 A1
(43) Pub. Date: Jul. 12, 2018

(54) VEHICLE BATTERY RECHARGE CONTROLLER BASED ON A GASSING RATE

(71) Applicant: Ford Global Technologies, LLC, Dearborn, MI (US)

(72) Inventors: Jeff Raymond Mohr, Shelby Twp., MI (US); Hanyang B. Chen, Canton, MI (US); Michael J. Irby, Monroe, MI (US)

(21) Appl. No.: 15/403,859

(22) Filed: Jan. 11, 2017

(51) Int. Cl. B60L 11/18; H01M 10/44; H01M 10/06; H01M 10/42; H01M 10/48; H02J 7/00

(52) U.S. Cl. CPC B60L 11/1861; H01M 10/445; H01M 10/06; H01M 10/425; H01M 2010/4271; H02J 7/007; B60L 11/1872; H01M 2220/20; H01M 10/486

(57) ABSTRACT

Method and apparatus are disclosed for a vehicle battery recharge controller based on a gassing rate. An example vehicle includes a battery with a gassing sensor and a body control module with a battery management controller. The battery management controller decreases a voltage used to charge the battery in response to a gassing rate measured by the gassing sensor satisfying a first threshold. Additionally, the battery management controller increases the voltage used to charge the battery in response to a gassing rate measured by the gassing sensor satisfying a second threshold lower than the first threshold.

### TECHNICAL FIELD

The present disclosure generally relates to a vehicle electrical system and, more specifically, a vehicle battery recharge controller based on a gassing rate.

### BACKGROUND

Vehicles use rechargeable lead-acid batteries to start an engine, provide power to vehicle systems, and store electric energy recollected by the vehicle while braking and decelerating. Permanent sulfation is one of the main causes of battery failure. Sulfation is a buildup of lead sulfate crystals in the battery. Sulfation shortens the useful life of the battery, can lead to longer charging times, and reduce cold crank capacity of the battery.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for a vehicle battery recharge controller based on a gassing rate. A disclosed example vehicle includes a battery with a gassing sensor and a body control module with a battery management controller. The battery management controller decreases a voltage used to charge the battery in response to a gassing rate measured by the gassing sensor satisfying a first threshold. Additionally, the battery management controller increases the voltage used to charge the battery in response to a gassing rate measured by the gassing sensor satisfying a second threshold lower than the first threshold.

A disclosed example vehicle includes a battery, a battery management system coupled to the battery, and a body control module including a battery management controller. The example battery management system measures a voltage level, a current, a temperature and a state of charge of the battery. The battery management controller determines a gassing rate of the battery based on the voltage level, the current, the temperature and the state of charge of the battery. Additionally, the battery management controller decreases voltage used to charge the battery in response to the gassing rate satisfying a first threshold. The battery management controller also increases the voltage used to charge the battery in response to a gassing rate satisfying a second threshold lower than the first threshold.

An example disclosed method to recharge a vehicle battery includes, in response to a gassing rate measured by a gassing sensor satisfying a first threshold, decreasing a voltage used to charge the battery. The example method also includes, in response to a gassing rate measured by the gassing sensor satisfying a second threshold lower than the first threshold, increasing the voltage used to charge the battery.

A tangible computer readable medium comprising instructions that, when executed, cause a body control module to, in response to a gassing rate measured by a gassing sensor satisfying a first threshold, decrease an output of a voltage regulator used to charge the battery. Additionally, the instructions, when executed, cause the body control module to, in response to a gassing rate measured by the gassing sensor satisfying a second threshold lower than the first threshold, increase the output of the voltage regulator used to charge the battery.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a block diagram of the electrical components of a vehicle used to charge a battery in accordance with the teachings of this disclosure.

FIG. 2 is a flowchart of a method to charge the battery based on a measured gassing rate, which may be implemented by the electrical components of FIG. 1.

FIG. 3 is a flowchart of a method to charge the battery based on a measured gassing rate and/or a predicted gassing rate, which may be implemented by the electrical components of FIG. 1.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Battery sulfation is caused, in part, by repeated cycles of insufficient charging of the battery. As such, ideally, the battery would be recharged as quickly as possible. However, charging the battery quickly with a high voltage causes water lost due gassing. The water loss can lead to dehydration of the electrolyte in the battery and exposure of the internal battery contacts to air which causes corrosion. Over the expected life of the battery (e.g., thirty-six months, etc.), there is an acceptable percentage (e.g., three percent, five percent, ten percent, etc.) of water loss due to gassing that does not substantially impair the functioning of the battery.

As disclosed below, a battery management controller charges a battery when the non-battery part of the power system of the vehicle is producing a surplus of power (e.g., when the engine is running, during breaking and/or deceleration, etc.) (sometimes referred to herein as a “charging session”). The battery management controller determines a gassing rate when charging the battery. In some examples, the battery management controller measures the actual gassing rate with a gassing sensor affixed to the battery. Alternatively or additionally, in some examples, the battery management controller estimates the gassing rate based on measurements (e.g., battery voltage, current, internal temperature, state-of-charge, etc.) from a battery management system (BMS) connected to the battery. The battery management controller compares the gassing rate to an upper threshold and a lower threshold. The upper threshold is set to prevent more than a certain percentage (e.g., three percent, five percent, ten percent, etc.) of the water in the battery is lost over the expected life of the battery. The lower threshold is so that the charging voltage slows sulfation. When the gassing rate satisfies (e.g., is greater than) the upper threshold, the battery management controller decreases the voltage to charge the battery. When the gassing rate satisfies (e.g., is less than) the lower threshold, the battery management controller increases the voltage to charge the battery.

From time-to-time (e.g., every sixty to ninety days, etc.), the battery management controller activates a refresh mode. During the refresh mode, the battery management controller increases the upper threshold and the lower threshold to increase the permissible and minimum gassing rate to facilitate a more rigorous charging. In some examples, the battery management controller remains in the refresh mode for a set period of accumulative time (e.g., one hour, two hours, etc.). As used herein, the accumulative time referred to a total amount of charging time that may be spread over different charging sessions. Alternatively, in some examples, the battery management controller remains in the refresh mode based on a threshold total accumulated gassing.

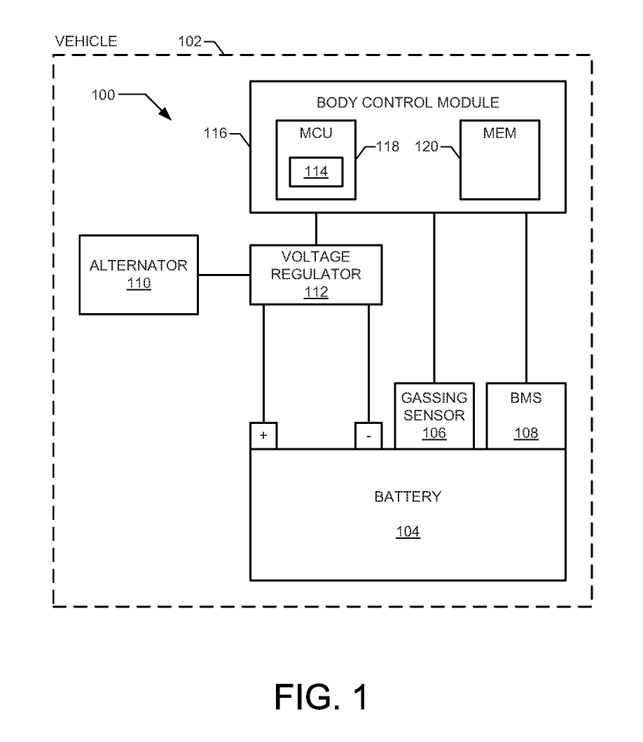

FIG. 1 is a block diagram of the electrical components 100 of a vehicle 102 used to charge a battery 104 in accordance with the teachings of this disclosure. The vehicle 102 may be a standard gasoline powered vehicle, a hybrid vehicle, an electric vehicle, a fuel cell vehicle, and/or any other mobility implement type of vehicle. The vehicle 102 includes parts related to mobility, such as a powertrain with an engine, a transmission, a suspension, a driveshaft, and/or wheels, etc. The vehicle 102 may be non-autonomous, semi-autonomous (e.g., some routine motive functions controlled by the vehicle 102), or autonomous (e.g., motive functions are controlled by the vehicle 102 without direct driver input). In the illustrated example, the vehicle 102 includes the battery 104, a gassing sensor 106, a battery management system (BMS) 108, an alternator 110, a voltage regulator 112, a battery management controller 114, and a body control module 116.

The battery 104 may be any suitable vehicle battery. For example, the battery 104 may be an acid-lead battery. The battery 104 provides charge to crank the engine of the vehicle 102 and provides power when the ignition of the vehicle 102 is off. Battery sulfation is a common mode of failure for the battery 104. Battery sulfation is due to a low state-of-charge (SOC) of the battery 104. Ideally, for batteries 104 with a low SOC, the battery 104 should be charged as fast as possible when the alternator 110 is on. The battery 104 can be charged faster with a higher charging voltage. However, battery gassing will occur due to water decomposition when charging voltage is higher than a gassing voltage. Because battery gassing is a complex process that is a function of battery temperature, charging voltage, charging current, battery SOC, water loss history, and battery aging status, the gassing voltage varies from battery 104 to battery 104 and over time.

The gassing sensor 106 is affixed to the battery 104. In some examples, the gassing sensor 106 is attached to the battery 104 externally. Alternatively, in some examples, the gassing sensor 106 is integrated into a body of the battery 104. When the battery 104 is charging, at the gassing voltage, the water in the electrolyte of the battery 104 begins to gasify. The gassing sensor 106 measures pressure of the produced gas. A higher pressure measurement is indicative of more gas being generated by the battery 104.

The BMS 108 is affixed to the battery 104. The BMS 108 includes sensors to measure properties of the battery 104. The BMS 108 measures battery temperature, battery voltage, battery current, and/or battery SOC. The BMS 108 is communicatively coupled to the body control module 116 via a vehicle data bus, such as a local interconnect network (LIN) data bus (International Standards Organization (ISO) 17987 Parts 1 through 7) or a controller area network (CAN) data bus (ISO 11898-1)

The alternator 110 is mechanically connected to the engine. The alternator 110 converts the mechanical energy from the engine into electrical energy. The alternator 110 provides direct current (DC) power based on the revolutions per minute of the engine. The voltage regulator 112 is electrically connected to the alternator 110 and the battery 104. The voltage regulator 112 facilitates delivering a variable voltage to charge the battery 104 based on an upper gassing threshold and a lower gassing threshold as disclosed below.

The battery management controller 114 monitors determines the gassing rate of the battery 104. In the illustrated example, the battery management controller 114 monitors determines the gassing rate with the gassing sensor 106. In some examples, when the battery 104 does not include the gassing sensor 106 or the gassing sensor 106 is malfunctioning, the battery management controller 114 estimates the gassing rate from measurements (e.g., the battery temperature, the battery voltage, the battery current, and the SOC, etc.) provided by the BMS 108. In such examples, the battery management controller 114 estimates the gassing rate in accordance with Equation (1) below.

R_{G}=F_{T}*F_{V}*F_{SOCC} Equation (1)

In Equation (1) above, R_{G} is the estimated gassing rate, F_{T} is a gassing factor based on the battery temperature, F_{V} is a gassing factor based on the battery voltage, and F_{SOCC} is a gassing factor based on the SOC and the battery current. The gassing factor based on the battery temperature (F_{T}) is retrieved from a one-dimensional temperature lookup table stored in memory (e.g., the memory 120 of the body control module 116 below) using the battery temperature measured by the BMS 108. In some examples, the temperature lookup table is based on an empirical model developed with measured data calibrated for different batteries. The gassing factor based on the battery voltage (F_{V}) is retrieved from a one-dimensional voltage lookup table stored in the memory using the battery voltage measured by the BMS 108. In some examples, the voltage lookup table is based on an empirical model developed with measured data calibrated for different batteries. The gassing factor based on the SOC and the battery current (F_{SOCC}) is retrieved from a two-dimensional SOC-Current lookup table stored in the memory using the SOC and battery current measured by the BMS 108. In some examples, the two-dimensional SOC-Current lookup table is based on an empirical relationship derived from measured data for different batteries.

The battery management controller 114 determines an upper gassing rate threshold and a lower gassing rate threshold. The upper gassing rate threshold is selected so that, including when the battery management controller 114 is in refresh mode (as disclosed below), the battery 104 does not lose more water than a determined percentage (e.g., three percent, five percent, ten percent, etc.) over the course of the expected life of the battery 104 (e.g., thirty-six months, etc.). For example, the upper gassing rate threshold may be 0.2 milliliters (ml)/hour. The lower gassing rate threshold is selected so that the voltage used to charge the battery 104 hinders sulfation. For example, the upper gassing rate threshold may be 0.1 ml/hour.

The battery management controller 114 tracks the water loss of the battery 104 by integrating the gassing rate. In some examples, the battery management controller 114 gradually lowers the upper gassing rate threshold and the lower gassing rate threshold over the expected life of the battery 104. Alternatively or additionally, in some examples, the battery management controller 114 gradually lowers the upper gassing rate threshold and the lower gassing rate threshold when lifetime water loss of the battery 104 is greater than the target total water loss. In some examples, the battery management controller 114 increases the upper gassing rate threshold and the lower gassing rate threshold when the current water loss of the battery 104 is below a target water loss based on the current age of the battery 104. For example, if the battery 104 originally had 4086 ml of electrolyte, the target total water loss is ten percent (408.6 ml), the battery 104 is 18 months old (50 percent of the expected life), and the current water loss is 158 ml (3.9 percent), the battery management controller 114 may increase the upper gassing rate threshold and the lower gassing rate threshold.

From time-to-time (e.g., every sixty days, every ninety days, etc.), the battery management controller 114 enter refresh mode. The refresh mode aggressively charges the battery 104 to promote the health of the battery (e.g., by causing the sulfuric acid and the electrolyte in the battery 104 to mix, etc.). In the refresh mode, the battery management controller 114 increases the upper gassing rate threshold and the lower gassing rate threshold (sometimes referred to as “an upper refresh threshold” and “a lower refresh threshold” respectively). The battery management controller 114 remains in the refresh mode until (a) the battery 104 has been charged for an accumulated period of time (e.g., one hour, two hours, etc.) or (b) a threshold level of gassing has been satisfied. In some examples, the threshold level of gassing is a portion of the total allowable gassing (e.g., three percent, five percent, or ten percent of the water in the battery 104, etc.). For example, if the total allowable gassing is ten percent, the threshold level of gassing may be five percent divided by a number of times the battery management controller 114 enters the refresh mode over the expected life of the battery 104. In such an example, if the battery management controller 114 enters the refresh mode every ninety days, the threshold level of gassing may be 0.42 percent of the water content of the battery 104.

The follow example describes setting the upper gassing rate threshold and the lower gassing rate threshold. In the example, the battery 104 originally has 4086 milliliters (ml) of electrolyte. Over the expected life of the battery 104, the expected total charging time for the battery is 2000 hours. In the example, the target total water loss is 10 percent, 9.41 percent of which is budgeted for when the battery management controller 114 is in regular mode (e.g., not refresh mode) and 0.59 percent is budgeted for when the battery management controller 114 is in refresh mode. In such an example, the upper gassing rate threshold in regular mode may be 0.19 ml/hour (4086*0.0941/2000) and the lower gassing rate threshold may be 0.1 ml/hour. In the example, if the battery management controller 114 enters the refresh mode every ninety days (e.g., 12 times over the expected life of the battery 104), the target water loss for every refresh mode may be 2.0 ml (4086*0.0059/12). As a result, the battery management controller 114 may set the upper refresh threshold to 2.0 ml/hour and the lower refresh threshold to 1.0 ml/hour.

When the battery 104 is charging (e.g., the alternator is providing voltage and current), the battery management controller 114 monitors the gassing rate. When the gassing rate satisfies (e.g., is greater than) (a) the upper gassing rate threshold or (b) the upper refresh threshold (if the battery management controller 114 is in the refresh mode), the battery management controller 114 decreases, via the voltage regulator 112, the voltage supplied to recharge the battery 104. When the gassing rate satisfies (e.g., is less than) (a) the lower gassing rate threshold or (b) the lower refresh threshold (if the battery management controller 114 is in the refresh mode), the battery management controller 114 increases, via the voltage regulator 112, the voltage supplied to recharge the battery 104.

The body control module 116 controls various subsystems of the vehicle 102. For example, the body control module 116 may control power windows, power locks, an immobilizer system, and/or power mirrors, etc. The body control module 116 includes circuits to, for example, drive relays (e.g., to control wiper fluid, etc.), drive brushed direct current (DC) motors (e.g., to control power seats, power locks, power windows, wipers, etc.), drive stepper motors, and/or drive LEDs, etc. In the illustrated examples, the body control module 116 includes a processor or controller 118 and memory 120. In the illustrated example, the body control module 116 is structured to include battery management controller 114. Alternatively, in some examples, the battery management controller 114. may be incorporated into another electronic control unit (ECU), such as a battery management unit or a power train control unit.

The processor or controller 118 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 120 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), and/or read-only memory. In some examples, the memory 120 includes multiple kinds of memory, particularly volatile memory and non-volatile memory. The memory 120 stores a timer to determine when the battery management controller 114 is to enter the refresh mode. In some examples, the memory 120 stores the one-dimensional temperature lookup table, the one-dimensional voltage lookup table, and the two-dimensional SOC-Current lookup table. Additionally, in some examples, the memory 120 stores the current age of the battery 104 and the accumulated current water loss of the battery 104.

The memory 120 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 120, the computer readable medium, and/or within the processor 118 during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

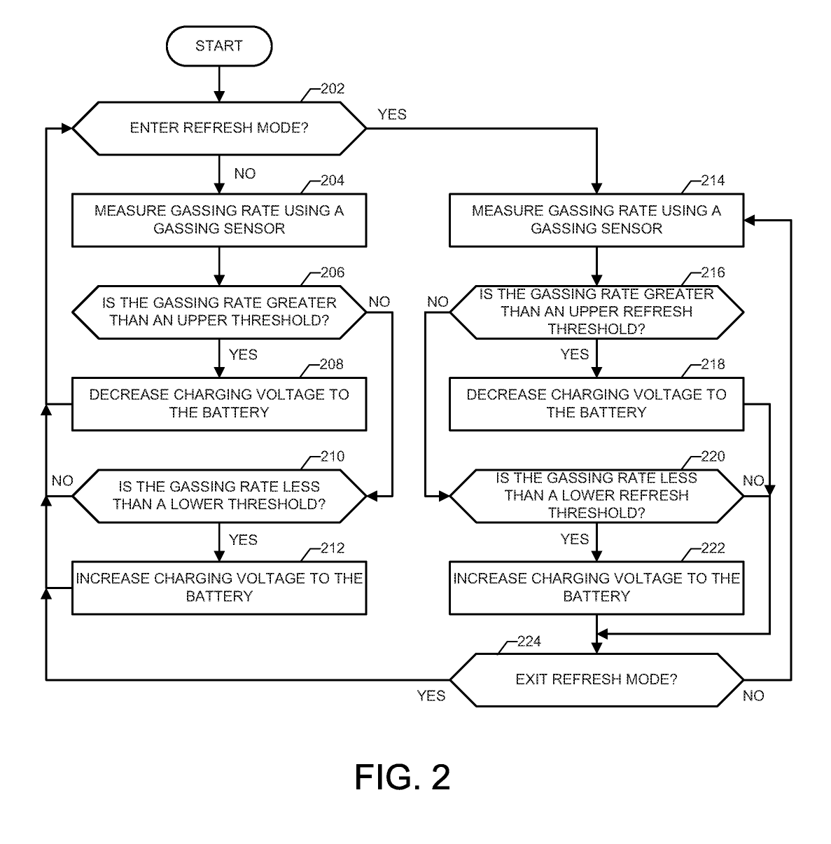

FIG. 2 is a flowchart of a method to charge the battery 104 based on a measured gassing rate, which may be implemented by the electrical components 100 of FIG. 1. Initially, at block 202, the battery management controller 114 determines whether to enter the refresh mode based on the amount of time that has elapsed since the last time it entered refresh mode. If the battery management controller 114 is not to enter the refresh mode, the method continues at block 204. Otherwise, if the battery management controller 114 is to enter the refresh mode, the method continues at block 214.

At block 204, the battery management controller 114 measures the gassing rate with the gassing sensor 106. At block 206, the battery management controller 114 determines whether the gassing rate measured at block 204 is greater than the upper gassing rate threshold. If the gassing rate is greater than or equal to the upper gassing rate threshold, the method continues to block 208. Otherwise, if the gassing rate is less than the upper gassing rate threshold, the method continues at block 210. At block 208, the battery management controller 114 decreases, via the voltage regulator 112, the voltage to charge the battery 104. At block 210, the battery management controller 114 determines whether the gassing rate measured at block 204 is less than the lower gassing rate threshold. If the gassing rate is less than the lower gassing rate threshold, the method continues at block 212. Otherwise, if the gassing rate is greater than or equal to the lower gassing rate threshold, the method returns to block 202. At block 212, the battery management controller 114 increases, via the voltage regulator 112, the voltage to charge the battery 104.

At block 214, the battery management controller 114 measures the gassing rate with the gassing sensor 106. At block 216, the battery management controller 114 determines whether the gassing rate measured at block 214 is greater than the upper refresh threshold. If the gassing rate is greater than or equal to the upper refresh threshold, the method continues to block 218. Otherwise, if the gassing rate is less than the upper refresh threshold, the method continues at block 220. At block 218, the battery management controller 114 decreases, via the voltage regulator 112, the voltage to charge the battery 104. At block 220, the battery management controller 114 determines whether the gassing rate measured at block 214 is less than the lower gassing rate threshold. If the gassing rate is less than the lower gassing rate threshold, the method continues at block 222. Otherwise, if the gassing rate is greater than or equal to the lower gassing rate threshold, the method continues to block 224. At block 222, the battery management controller 114 increases, via the voltage regulator 112, the voltage to charge the battery 104. At block 224, the battery management controller 114 determines whether to exit the refresh mode. In some examples, the battery management controller 114 determines to exit the refresh mode after a threshold period of time (e.g., two hours, etc.). Alternatively or additionally, in some examples, the battery management controller 114 determines to exit the refresh mode after, during the refresh period, accumulating a target water loss (e.g., 2.0 ml, etc.). If the battery management controller 114 determines to exit the refresh mode, the method returns to block 202. Otherwise, if the battery management controller 114 determines not to exit the refresh mode, the method returns to block 214.

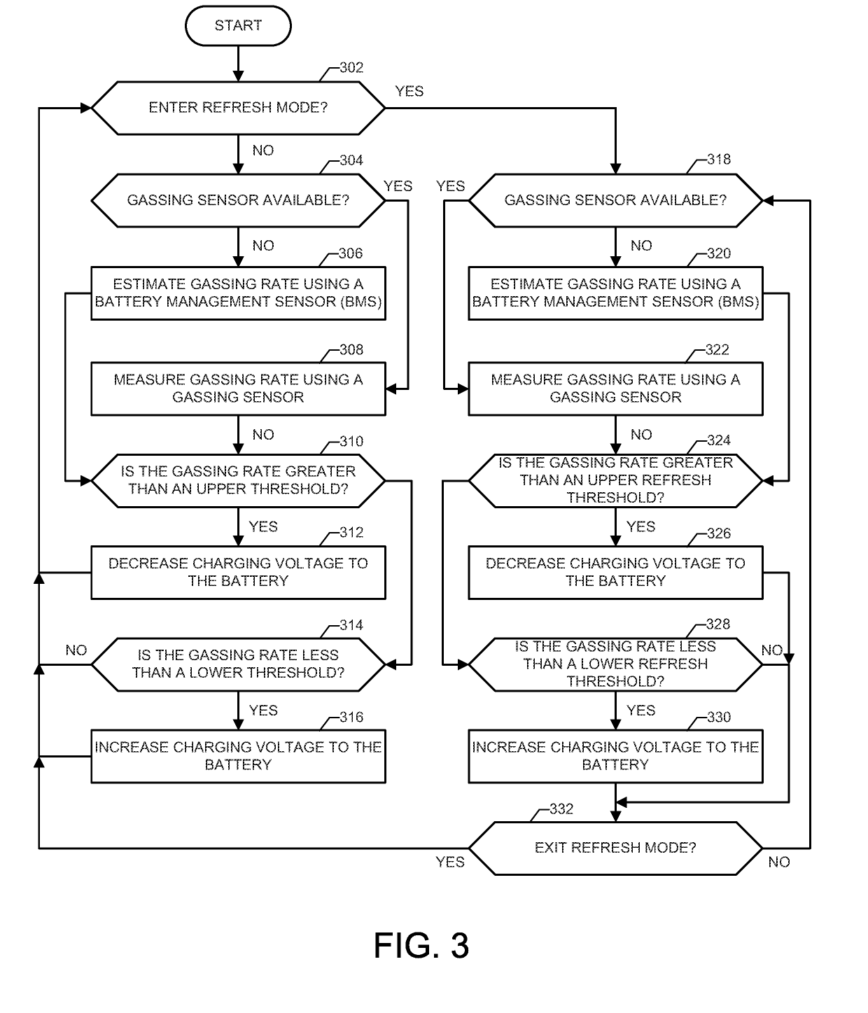

FIG. 3 is a flowchart of a method to charge the battery 104 based on a measured gassing rate and/or a predicted gassing rate, which may be implemented by the electrical components 100 of FIG. 1. Initially, at block 302, the battery management controller 114 determines whether to enter the refresh mode based on the amount of time that has elapsed since the last time it entered refresh mode. If the battery management controller 114 is not to enter the refresh mode, the method continues at block 304. Otherwise, if the battery management controller 114 is to enter the refresh mode, the method continues at block 318.

At block 304, the battery management controller 114 determines whether the gassing sensor 106 is available. In some example, the battery 104 does not include the gassing sensor 106. Alternatively, in some examples, the gassing sensor 106 is malfunctioning. If the gassing sensor 106 is not available, the method continues at block 306. Otherwise, if the gassing sensor is available, the method continues at block 308. At block 306, the battery management controller 114 estimates the gassing rate based on properties of the battery 104 measured by the BMS 108. In some examples, the battery management controller 114 estimates the gassing rate in accordance with Equation (1) above. At block 308, the battery management controller 114 measures the gassing rate with the gassing sensor 106.

At block 310, the battery management controller 114 determines whether the gassing rate estimated at block 306 or measured at block 308 is greater than the upper gassing rate threshold. If the gassing rate is greater than or equal to the upper gassing rate threshold, the method continues to block 312. Otherwise, if the gassing rate is less than the upper gassing rate threshold, the method continues at block 314. At block 312, the battery management controller 114 decreases, via the voltage regulator 112, the voltage to charge the battery 104. At block 314, the battery management controller 114 determines whether the gassing rate measured at block 204 is less than the lower gassing rate threshold. If the gassing rate is less than the lower gassing rate threshold, the method continues at block 316. Otherwise, if the gassing rate is greater than or equal to the lower gassing rate threshold, the method returns to block 302. At block 316, the battery management controller 114 increases, via the voltage regulator 112, the voltage to charge the battery 104.

At block 318, the battery management controller 114 determines whether the gassing sensor 106 is available. If the gassing sensor 106 is not available, the method continues at block 320. Otherwise, if the gassing sensor is available, the method continues at block 322. At block 320, the battery management controller 114 estimates the gassing rate based on properties of the battery 104 measured by the BMS 108. In some examples, the battery management controller 114 estimates the gassing rate in accordance with Equation (1) above. At block 322, the battery management controller 114 measures the gassing rate with the gassing sensor 106.

At block 324, the battery management controller 114 determines whether the gassing rate estimated at block 320 or measured at block 322 is greater than the upper gassing rate threshold. If the gassing rate is greater than or equal to the upper gassing rate threshold, the method continues to block 326. Otherwise, if the gassing rate is less than the upper gassing rate threshold, the method continues at block 328. At block 326, the battery management controller 114 decreases, via the voltage regulator 112, the voltage to charge the battery 104. At block 328, the battery management controller 114 determines whether the gassing rate estimated at block 320 or measured at block 322 is less than the lower gassing rate threshold. If the gassing rate is less than the lower gassing rate threshold, the method continues at block 330. Otherwise, if the gassing rate is greater than or equal to the lower gassing rate threshold, the method continues to block 332. At block 330, the battery management controller 114 increases, via the voltage regulator 112, the voltage to charge the battery 104.

At block 332, the battery management controller 114 determines whether to exit the refresh mode. In some examples, the battery management controller 114 determines to exit the refresh mode after a threshold period of time (e.g., two hours, etc.). Alternatively or additionally, in some examples, the battery management controller 114 determines to exit the refresh mode after, during the refresh period, accumulating a target water loss (e.g., 2.0 ml, etc.). If the battery management controller 114 determines to exit the refresh mode, the method returns to block 302. Otherwise, if the battery management controller 114 determines not to exit the refresh mode, the method returns to block 318.

The flowcharts of FIGS. 2 and 3 are representative of machine readable instructions stored in memory (such as the memory 120 of FIG. 1) that comprise one or more programs that, when executed by a processor (such as the processor 118 of FIG. 1), cause the body control module 116 to implement the example battery management controller 114 of FIG. 1. Further, although the example program(s) is/are described with reference to the flowcharts illustrated in FIGS. 2 and 3, many other methods of implementing the example battery management controller 114 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a battery;
a gassing sensor coupled to the battery; and
a body control module including a battery management controller to:
in response to a gassing rate measured by the gassing sensor satisfying a first threshold, decrease voltage used to charge the battery; and
in response to the gassing rate satisfying a second threshold lower than the first threshold, increase the voltage used to charge the battery.

2. The vehicle of claim 1, wherein the battery management controller is to periodically enter a refresh mode.

3. The vehicle of claim 2, wherein, in the refresh mode, the battery management controller is to increase the first and second thresholds.

4. The vehicle of claim 2, wherein, in the refresh mode, the battery management controller is to:
determine an accumulated water loss while in the refresh mode; and
exit the refresh mode when the accumulated water loss satisfies a third threshold.

5. The vehicle of claim 1, wherein the first and second thresholds are based on a target water loss for the battery, an original amount of electrolyte in the battery, and an expected life of the battery.

6. The vehicle of claim 1, wherein the second threshold is greater than zero.

7. The vehicle of claim 1, wherein the battery management controller is to, in response to not receiving a gassing rate measurement, estimate the gassing rate based on parameters of the battery measured by a battery management system.

8. The vehicle of claim 1, wherein the battery management controller is to decrease the first and second thresholds over an expected life of the battery.

9. The vehicle of claim 1, wherein the battery management controller is to determine a target accumulated water loss for the battery based on an age of the battery and an actual accumulated water loss for the battery.

10. The vehicle of claim 9, wherein the battery management controller is to:
in response to the target accumulated water loss being greater than the actual accumulated water loss, increase the first and second thresholds; and
in response to the target accumulated water loss being less than the actual accumulated water loss, decrease the first and second thresholds.

11. A method to recharge a vehicle battery comprising:
in response to a gassing rate measured by a gassing sensor satisfying a first threshold, decreasing a voltage used to charge the vehicle battery; and
in response to a gassing rate measured by the gassing sensor satisfying a second threshold lower than the first threshold, increasing the voltage used to charge the vehicle battery.

12. The method of claim 11, including periodically entering a refresh mode.

13. The method of claim 12, including in the refresh mode, increasing the first and second thresholds.

14. The method of claim 12, including, in the refresh mode:
determining an accumulated water loss while in the refresh mode; and
exiting the refresh mode when the accumulated water loss satisfies a third threshold.

15. The method of claim 11, wherein the first and second thresholds are based on a target water loss for the vehicle battery, an original amount of electrolyte in the vehicle battery, and an expected life of the vehicle battery.

16. The method of claim 11, wherein the second threshold is greater than zero.

17. The method of claim 11, including, in response to not receiving a gassing rate measurement, estimating the gassing rate based on parameters of the vehicle battery measured by a battery management system.

18. The method of claim 11, including decreasing the first and second thresholds over an expected life of the vehicle battery.

19. The method of claim 11, including:
determining a target accumulated water loss for the vehicle battery based on an age of the vehicle battery and an actual accumulated water loss for the vehicle battery;
in response to the target accumulated water loss being greater than the actual accumulated water loss, increasing the first and second thresholds; and
in response to the target accumulated water loss being less than the actual accumulated water loss, decreasing the first and second thresholds.

20. A tangible computer readable medium comprising instructions that, when executed, cause a body control module to:
in response to a gassing rate measured by a gassing sensor satisfying a first threshold, decrease an output of a voltage regulator used to charge a battery; and
in response to a gassing rate measured by the gassing sensor satisfying a second threshold lower than the first threshold, increase the output of the voltage regulator used to charge the battery.

21. A vehicle comprising:
a battery;
a battery management system coupled to the battery, the battery management system to measure a voltage level, a current, a temperature and a state of charge of the battery; and
a body control module including a battery management controller to:
determine a gassing rate of the battery based on the voltage level, the current, the temperature and the state of charge of the battery;
decrease voltage used to charge the battery in response to the gassing rate satisfying a first threshold; and
increase the voltage used to charge the battery in response to a gassing rate satisfying a second threshold lower than the first threshold.
